(19) United States
(12) Patent Application Publication
(10) Pub. No.: US 2026/0091741 A1
(43) Pub. Date: Apr. 2, 2026

(54) VEHICLE-MOUNTED ELECTRONIC DEVICE HOLDER

(71) Applicant: SHENZHEN EARY INNOVATION DESIGN CO.,LTD, SHENZHEN (CN)

(72) Inventor: SHIWANG ZHOU, SHENZHEN (CN)

(21) Appl. No.: 19/340,898

(22) Filed: Sep. 26, 2025

(30) Foreign Application Priority Data
Sep. 27, 2024 (CN) 202422380713.7

(51) Int. Cl. B60R 11/02; B60R 11/00

(52) U.S. Cl. CPC B60R 11/02; B60R 2011/001; B60R 2011/0059

(57) ABSTRACT

A vehicle-mounted electronic device holder includes at least one bracket body and a hanging bar foldably disposed on a rear surface of an upper end of the at least one bracket body. When the hanging bar is unfolded in place, a positioning clamping gap for clamping a steering wheel is formed between the hanging bar and the rear surface of the upper end of the at least one bracket body. When in use, the at least one bracket body is attached to a front side of the steering wheel, and the hanging bar is unfolded, so that an upper portion of the steering wheel is clamped in the positioning clamping gap. Therefore, the at least one bracket body is assembled on the steering wheel. In this way, a laptop or a book is allowed to be placed on the at least one bracket body for reading, viewing, and operating.

### TECHNICAL FIELD

The present disclosure relates to a technical field of vehicle-mounted electronic device holders, and in particular to a vehicle-mounted electronic device holder.

### BACKGROUND

Currently, laptops and cars are common tools to improve the quality of young urban people. When it comes to staying in a car, using a laptop is a requirement for many office workers. When office workers are leisurely in their cars or work on temporary office work, laptops are usually nowhere to be placed. For a passenger sitting in a passenger seat or in a rear seat, the laptop is allowed to be placed on legs of the passenger for operation. However, for a driver, due to an existence of a steering wheel, the driver is unable to put the laptop on the legs, such that the driver needs to sit in the passenger seat or the rear seat before operating the laptop, which is troublesome. In addition, when an outside environment is not suitable for getting off the car, such as rain, snow, or strong winds, it is very troublesome for the driver to get off the car and change the seat. Therefore, it is necessary to provide a structure that facilitates the driver to place the laptop on the steering wheel to meet a need of the driver for operating the laptop in a driving seat.

### SUMMARY

The present disclosure provides a vehicle-mounted electronic device holder to solve problems in the prior art.

The vehicle-mounted electronic device holder comprises at least one bracket body and a hanging bar foldably disposed on a rear surface of an upper end of the at least one bracket body. When the hanging bar is unfolded in place, a positioning clamping gap for clamping a steering wheel is formed between the hanging bar and the rear surface of the upper end of the at least one bracket body.

In one embodiment of the present disclosure, the at least one bracket body comprises an accommodating slot. In a folded state, the hanging bar is accommodated in the accommodating slot.

In one embodiment of the present disclosure, the accommodating slot penetrates through the at least one bracket body from front to rear.

In one embodiment of the present disclosure, the upper end of the at least one bracket body comprises a protruding portion protruding forwardly. A rear side of the protruding portion defines a recess. The accommodating slot is defined in the recess.

In one embodiment of the present disclosure, the protruding portion is L-shaped and has a lateral end facing backward. The hanging bar is disposed on a longitudinal end of the protruding portion. The accommodating slot extends from the longitudinal end to the lateral end of the protruding portion. When the hanging bar is accommodated in place, a tail end of the hanging bar is located at a connection between the lateral end and the longitudinal end of the protruding portion.

In one embodiment of the present disclosure, a limiting block is disposed on the rear surface of the upper end of the at least one bracket body. The limiting block is disposed above the hanging bar. When the hanging bar is unfolded in place, the hanging bar abuts against a lower end of the limiting block.

In one embodiment of the present disclosure, a positioning groove configured to position the hanging bar is defined in the lower end of the limiting block. When the hanging bar is unfolded in place, the hanging bar is positioned in the positioning groove.

In one embodiment of the present disclosure, a head end of the hanging bar is longitudinally hinged to the at least one bracket body by a first rotating shaft. The hanging bar comprises an arc-shaped recess adapted to an arc-shaped outer edge of the steering wheel. When the hanging bar is unfolded in place, the arc-shaped recess is attached to an upper portion of the arc-shaped outer edge of the steering wheel.

In one embodiment of the present disclosure, when the hanging bar is accommodated in place, a tail end of the hanging bar is accommodated in a lower portion of the positioning clamping gap.

In one embodiment of the present disclosure, the hanging bar is columnar and has a ball head disposed on a tail end thereof, and the ball head and the hanging bar are integrated and are coaxially disposed.

In one embodiment of the present disclosure, the at least one bracket body comprises a holding bracket and a support bracket. The holding bracket and the support bracket are disposed side by side from front to rear. An upper end of the holding bracket and an upper end of the support bracket are longitudinally hinged. An angle adjustment assembly is disposed on the support bracket. The angle adjustment assembly is configured to adjust an inclined angle of the holding bracket. The hanging bar is disposed on the upper end of the holding bracket. The support bracket is disposed below the positioning clamping gap.

In one embodiment of the present disclosure, the angle adjustment assembly comprises a support rod, a sliding block, and a positioning unit. The support rod is longitudinally hinged to the support bracket. The sliding block is slidably disposed on the support bracket. The positioning unit is configured to position a position of the sliding block. The support rod is longitudinally hinged to the sliding block.

In one embodiment of the present disclosure, the positioning unit comprises a movable piece, snapping grooves, and an elastic abutting piece. The movable piece is longitudinally hinged to the sliding block. The snapping grooves are evenly defined in the holding bracket. The snapping grooves are corresponding to a sliding track of the sliding block. The elastic abutting piece is configured to provide an abutting force to force one end of the movable piece to snap into one of the snapping grooves.

In one embodiment of the present disclosure, a movable slot is defined in a rear sidewall of the sliding block. The movable slot penetrates through the sliding block from rear to front. The movable piece is disposed in the movable slot and is rotatably connected to the sliding block through a second rotating shaft. The elastic abutting piece is disposed above the second rotating shaft. One end of the support rod connected to the sliding block is located above the elastic abutting piece. When assembled in place, an upper end of the movable piece extends out of the movable slot.

In one embodiment of the present disclosure, the holding bracket comprises two guide ribs. The two guide ribs are respectively disposed on a left side and a right side of the sliding track of the sliding block. Guide grooves are defined in two opposite sidewalls of the two guide ribs along a length direction of the holding bracket. Guide protrusions matched with the guide grooves are disposed on the sliding block. When assembled in place, the two guide ribs are slidably attached to the sliding block.

In one embodiment of the present disclosure, the holding bracket and the support bracket are rectangular. A length of the holding bracket is greater than a length of the support bracket. When the holding bracket is assembled in place, the lower end of the holding bracket is located below a lower end of the support bracket.

In one embodiment of the present disclosure, a stopper is disposed on a lower end of a front side of the holding bracket. The stopper is configured to prevent an electronic device from sliding off the holding bracket.

In one embodiment of the present disclosure, the at least one bracket body comprises two bracket bodies disposed from left to right. The vehicle-mounted electronic device holder further comprises a spacing adjustment assembly configured to adjust a distance between the two bracket bodies.

When in use, the at least one bracket body is attached to a front side of the steering wheel, and then the hanging bar is unfolded, so that the positioning clamping gap is sleeved on an upper portion of the steering wheel, and the at least one bracket body is assembled on the steering wheel. In this way, the user is able to conveniently place a laptop or a book on the at least one bracket body for reading, viewing, and operating, etc. Therefore, the vehicle-mounted electronic device holder is highly practical.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a perspective schematic diagram of a vehicle-mounted electronic device holder shown in an unfolded state according to one embodiment of the present disclosure.

FIG. 2 is a side elevation schematic diagram of the vehicle-mounted electronic device holder assembled on a steering wheel according to one embodiment of the present disclosure.

FIG. 3 is another perspective schematic diagram of the vehicle-mounted electronic device holder according to one embodiment of the present disclosure.

FIG. 4 is a partial schematic diagram of the vehicle-mounted electronic device holder shown in FIG. 3.

FIG. 5 is a rear side perspective schematic diagram of the vehicle-mounted electronic device holder shown in FIG. 3.

FIG. 6 is a partial schematic diagram of the vehicle-mounted electronic device holder shown in FIG. 5.

FIG. 7 is another perspective schematic diagram of the vehicle-mounted electronic device holder according to one embodiment of the present disclosure.

FIG. 8 is a front side elevation schematic diagram of the vehicle-mounted electronic device holder according to one embodiment of the present disclosure.

FIG. 9 is a cross-sectional schematic diagram of the vehicle-mounted electronic device holder taken along a line A-A shown in FIG. 8.

FIG. 10 is a partial schematic diagram of the vehicle-mounted electronic device holder shown in FIG. 9.

FIG. 11 is a perspective schematic diagram of the vehicle-mounted electronic device holder shown in a folded state according to one embodiment of the present disclosure.

FIG. 12 is a front side elevation schematic diagram of the vehicle-mounted electronic device holder shown in the folded state according to one embodiment of the present disclosure.

FIG. 13 is a cross-sectional schematic diagram of the vehicle-mounted electronic device holder taken along a line B-B shown in FIG. 12.

FIG. 14 is a partial schematic diagram of the vehicle-mounted electronic device holder shown in FIG. 13.

FIG. 15 is a cross-sectional schematic diagram of the vehicle-mounted electronic device holder taken along a line C-C shown in FIG. 12.

FIG. 16 is a rear side elevation schematic diagram of the vehicle-mounted electronic device holder shown in the folded state according to one embodiment of the present disclosure.

FIG. 17 is a front side elevation schematic diagram of the vehicle-mounted electronic device holder where hanging bars thereof are shown in the folded state.

FIG. 18 is a cross-sectional schematic diagram of the vehicle-mounted electronic device holder taken along a line D-D shown in FIG. 17.

### DETAILED DESCRIPTION

The terms "first", "second", "third" and "fourth" etc., in the specification and claims of the present disclosure are configured to distinguish different objects, rather than to describe a specific order. Furthermore, the terms "including" and "having" and any variations thereof are intended to cover non-exclusive inclusions. For example, a process, method, system, product or device containing a series of steps or units is not limited to the listed steps or units, but optionally also comprises steps or units not listed, or optionally also other steps or units inherent to these processes, methods, products or devices.

Reference herein to "embodiment" means that a particular feature, structure, or characteristic described in connection with the embodiment may be included in at least one embodiment of the present disclosure. The appearances of the phrase in various places in the specification are not necessarily all referring to the same embodiment, nor are separate or alternative embodiments mutually exclusive of other embodiments. Those skilled in the art explicitly and implicitly understand that the embodiments described herein may be combined with other embodiments.

The term "a plurality of" means two or more. The term "and/or", describing the association relationship of the associated object, means that there may be three relationships. For example, "A and/or B" may mean that there is only an A, there is only a B, or there are both A and B. The character "/" generally means that the object before and after is a "or" relationship.

Furthermore, the terms "up, down, left, right, upper end, lower end, vertical" etc., representing orientation are referenced by the posture position of the device or device described in the scheme during normal use.

In order to make the purpose, technical solutions and features of the embodiments of the present disclosure clearer, the present disclosure is clearly and completely described in combination with the technical solutions in the embodiments of the present disclosure. Obviously, the described embodiments are some embodiments of the present disclosure, not all embodiments. Based on the embodiments of the present disclosure, all other embodiments obtained by those skilled in the art without putting in creative labor are within the protection scope of the present disclosure.

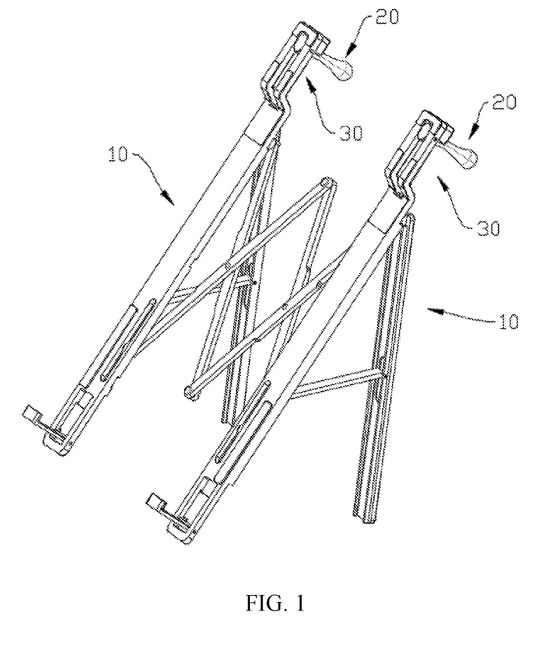

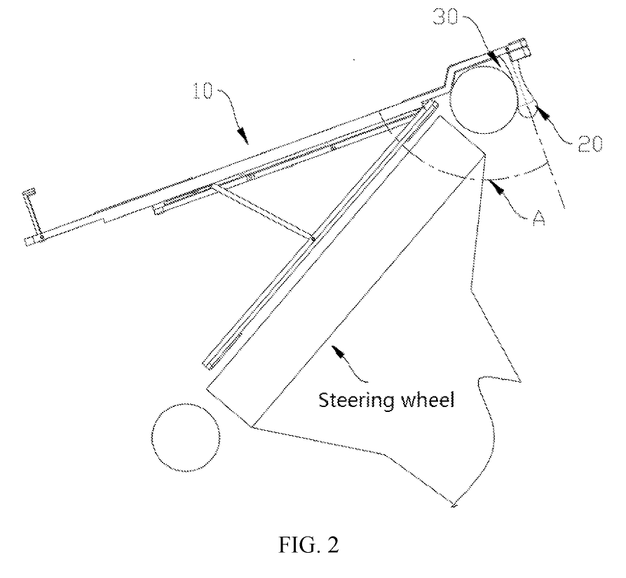

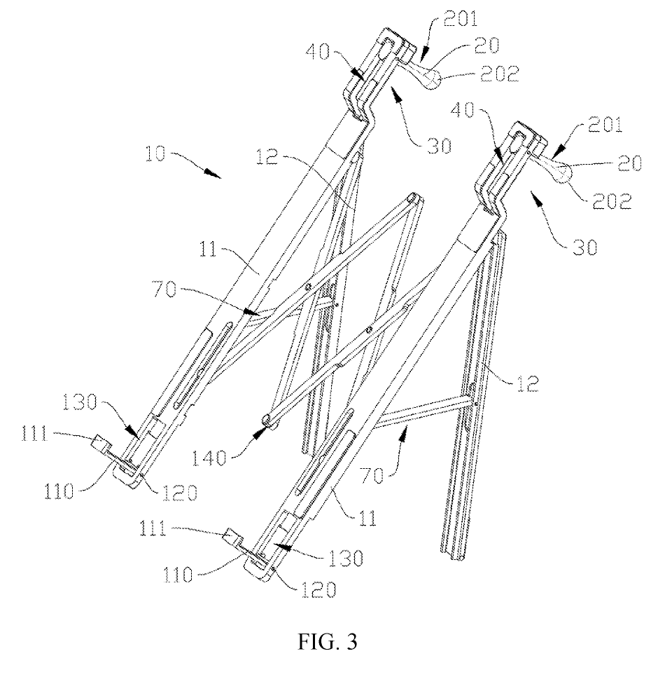

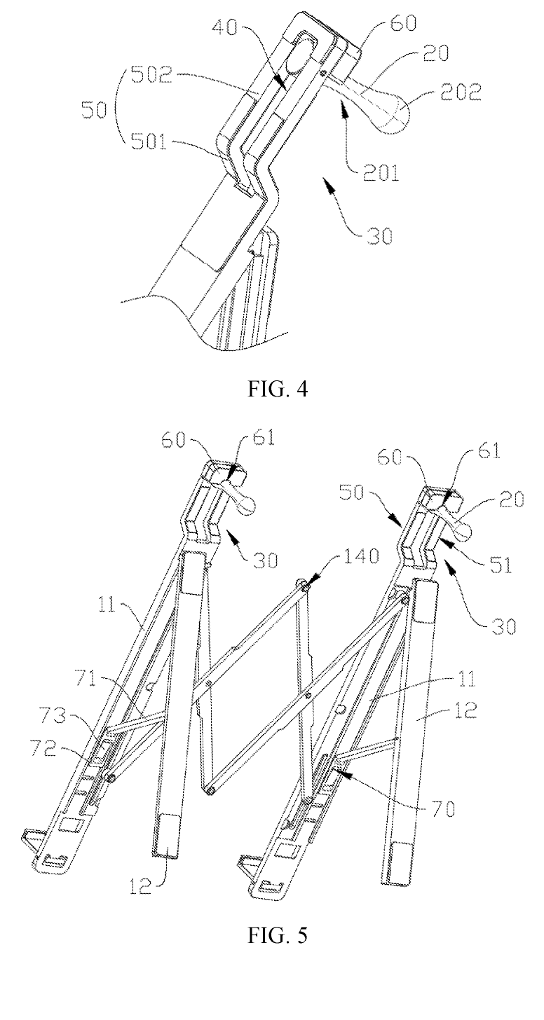

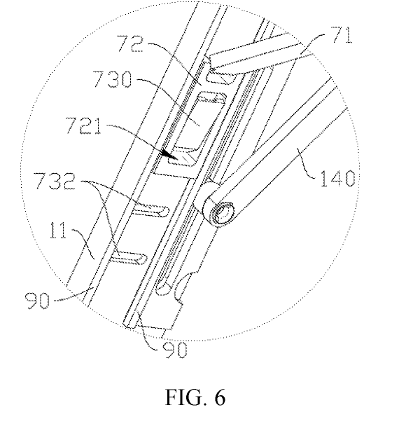

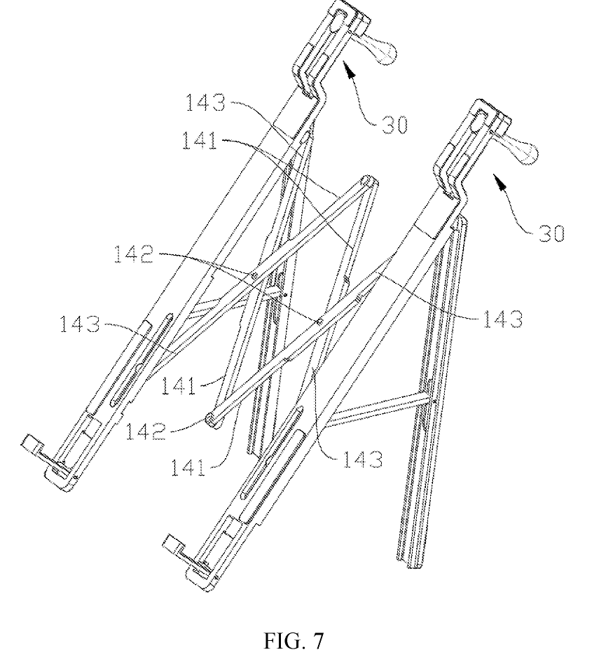

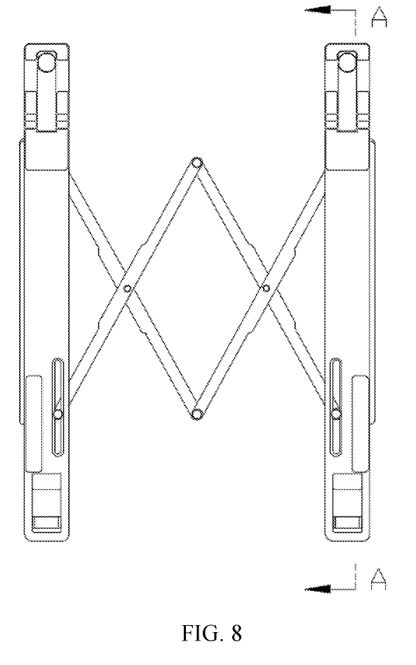

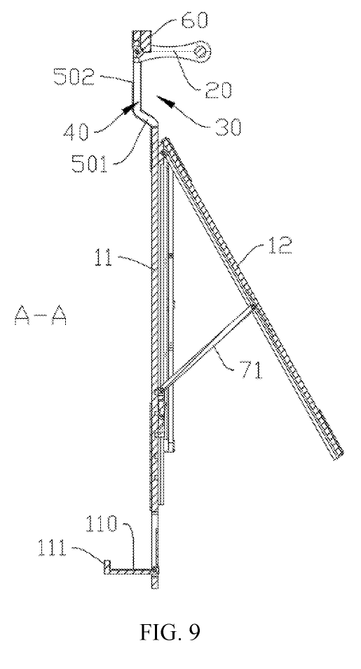

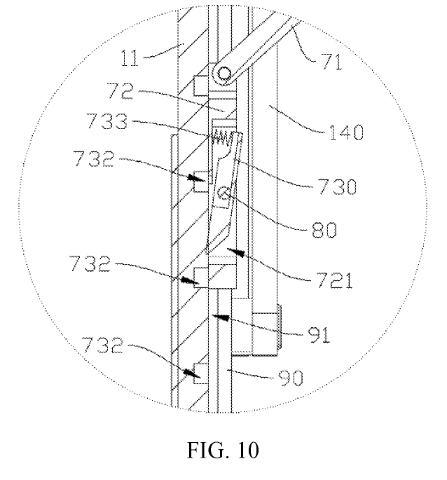

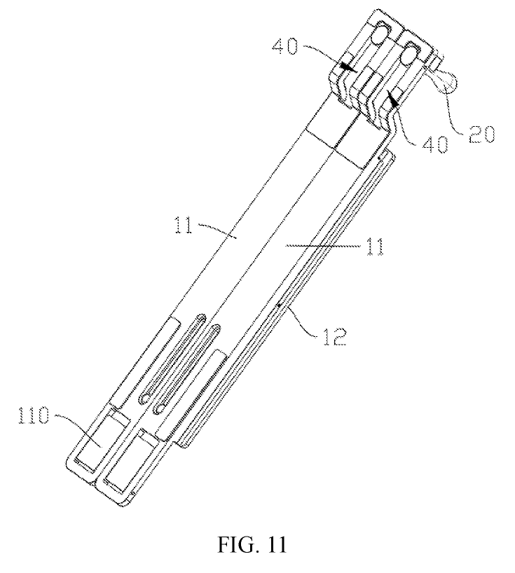

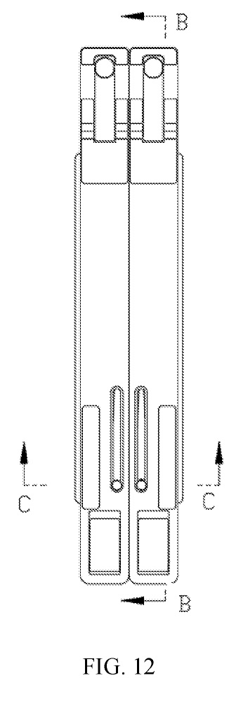

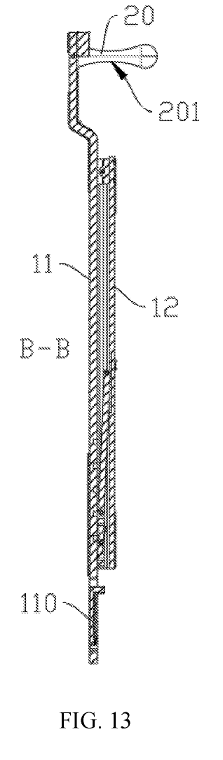

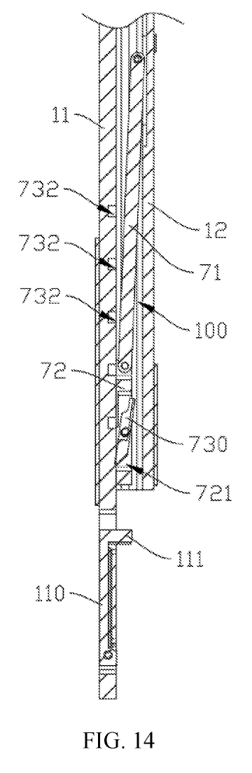

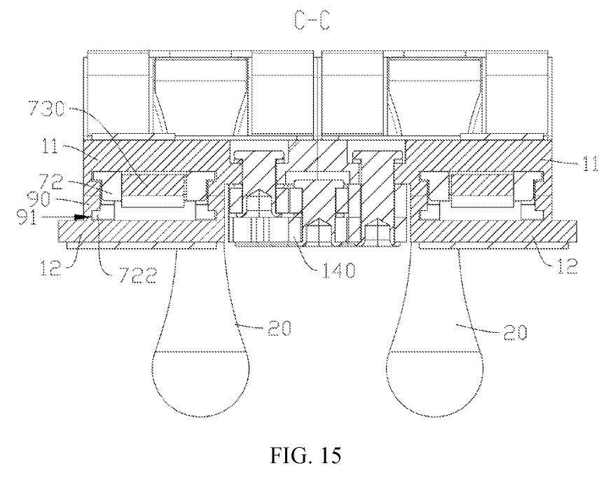

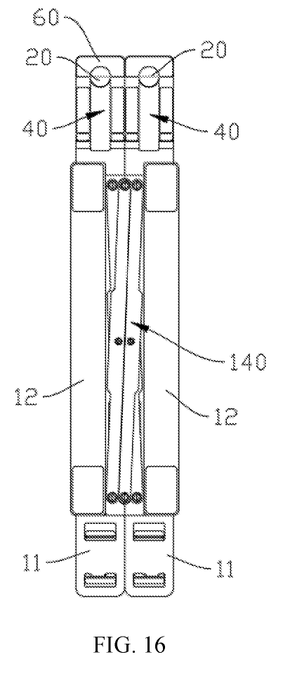

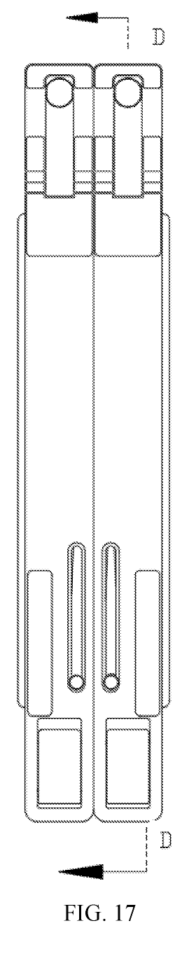

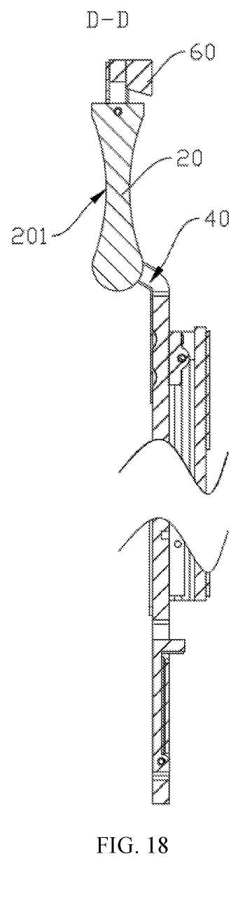

As shown in FIG. 1-18, embodiments of the present disclosure provide a vehicle-mounted electronic device holder. The vehicle-mounted electronic device holder comprises at least one bracket body 10 and a hanging bar 20 foldably disposed on a rear surface of an upper end of the at least one bracket body 10. When the hanging bar 20 is unfolded in place, the hanging bar 20 is unfolded to a right angle A perpendicular to the bracket body 10. Of course, the angle A may be an acute angle or an obtuse angle. When the angle A is the obtuse angle, a stop structure should be configured to prevent an electronic device from sliding off. Furthermore, a positioning clamping gap 30 for clamping a steering wheel is formed between the hanging bar 20 and the rear surface of the upper end of the at least one bracket body 10. When in use, the at least one bracket body 10 is attached to a front side of the steering wheel, and then the hanging bar 20 is unfolded, so that the positioning clamping gap 30 is sleeved on an upper portion of the steering wheel, and the at least one bracket body 10 is assembled on the steering wheel. In this way, the user is able to conveniently place a laptop or a book on the at least one bracket body 10 for reading, viewing, and operating, etc. Therefore, the vehicle-mounted electronic device holder is highly practical.

In the embodiment of the present disclosure, the at least one bracket body 10 comprises an accommodating slot 40. In a folded state, the hanging bar 20 is accommodated in the accommodating slot 40. In this way, a thickness of the at least one bracket body 10 is reduced in the folded state, which facilitates storage of the at least one bracket body 10.

Furthermore, the accommodating slot 40 penetrates through the at least one bracket body 10 from front to rear, so that the hanging bar 20 is allowed to be accommodated in the at least one bracket body 10. Moreover, a left sidewall and a right sidewall of the accommodating slot 40 are interfered with the hanging bar 20, so as to achieve clamping positioning of the hanging bar 20 by friction, thereby avoiding loosening and separating of the hanging bar 20 when the hanging bar is accommodated in the accommodating slot 40. Of course, a rotating shaft of the hanging bar is designed to be in a damp rotation manner to prevent the hanging bar from falling off after being accommodated in the accommodating slot 40.

In one embodiment of the present disclosure, the upper end of the at least one bracket body 10 comprises a protruding portion 50 protruding forwardly. A rear side of the protruding portion 50 defines a recess 51. The accommodating slot 40 is defined in the recess 51.

The protruding portion 50 has two functions. A first function of the protruding portion 50 is to further accommodate the hanging bar 20, so that the hanging bar 20 is closer to a front side of the at least one bracket body 10 after being accommodated in the accommodating slot. A second function of the protruding portion 50 is to make a position of the clamping positioning gap closer to the front side of the at least one bracket body. That is, the protruding portion 50 is to make the at least one bracket body 10 relatively away from the steering wheel. Therefore, when the at least one bracket body 10 is placed on a front surface of the steering wheel, the protruding portion 50 is opposed to a sidewall of a bulge of an operation button disposed on a center of the steering wheel, so as to avoid erroneous operation caused by horizontally moving the at least one bracket body 10 toward the operation button.

Specifically, the protruding portion 50 is L-shaped and has a lateral end 501 facing backward and a longitudinal end 502 facing upward. The hanging bar 20 is disposed on a rear side of the longitudinal end 502 of the protruding portion 50. The accommodating slot 40 extends from the longitudinal end 502 to the lateral end 501 of the protruding portion 50. When the hanging bar is accommodated in place, a tail end of the hanging bar 20 is located at a connection between the lateral end 501 and the longitudinal end 502 of the protruding portion 50, so that the hanging bar is hidden in a storage state. Furthermore, an anti-slip pad is disposed on a front side of the protruding portion 50 to increase a friction force between the laptop and the at least one bracket body 10 to prevent the laptop from slipping off.

In one embodiment of the present disclosure, a limiting block 60 is disposed on the rear surface of the upper end of the at least one bracket body 10. The limiting block 60 is disposed above the hanging bar 20. When the hanging bar 20 is unfolded in place, the hanging bar 20 abuts against a lower end of the limiting block 60. The limiting block 60 further limit and position the hanging bar 20.

In one embodiment of the present disclosure, a positioning groove 61 configured to position the hanging bar 20 is defined in the lower end of the limiting block 60. When the hanging bar 20 is unfolded in place, the hanging bar 20 is positioned in the positioning groove 61. The positioning groove 61 prevents the hanging bar 20 from shaking left and right and ensures the stability of the hanging bar 20.

In one embodiment of the present disclosure, a head end of the hanging bar 20 is longitudinally hinged to the at least one bracket body 10 by a first rotating shaft. The first rotating shaft is disposed in the accommodating slot 40. The hanging bar 20 comprises an arc-shaped recess 201 adapted to an arc-shaped outer edge of the steering wheel. When the hanging bar 20 is unfolded in place, the arc-shaped recess 201 is attached to an upper portion of the arc-shaped outer edge of the steering wheel, so as to increase a contact area with the arc-shaped outer edge of the steering wheel, avoiding excessive local pressure on the steering wheel and avoiding damage to the front surface of the steering wheel. Moreover, the arc-shaped recess 201 further makes the hanging bar 20 more stable after being attached to the steering wheel and plays an anti-slip and anti-falling role.

Specifically, when the hanging bar 20 is accommodated in place, a tail end of the hanging bar 20 is accommodated in a lower portion of the positioning clamping gap 30, and the hanging bar 20 is partially or fully accommodated in the accommodating slot 40, which improves the compactness of an overall structure of the at least one bracket body 10 after storage.

In one embodiment of the present disclosure, the hanging bar 20 is columnar and has a ball head 202 disposed on the tail end thereof. The tail end of the hanging bar 20 is one end of the hanging bar 20 away from the first rotating shaft. The ball head 202 and the hanging bar 20 are integrated and are coaxially disposed. An outer surface of the ball head 202 is smooth, so that there are no sharp portions on the hanging bar 20 during an assembling process, ensuring that a surface decorative layer of the steering wheel is not damaged and a design of the hanging bar 20 is more user-friendly. Furthermore, the arc-shaped recess 201 on the hanging bar 20 is disposed in an annular shape along a circumference of the hanging bar 20, so that the user feels more comfortable to hold when unfolding the hanging bar 20.

In one embodiment of the present disclosure, the at least one bracket body 10 comprises a holding bracket 11 and a support bracket 12. The holding bracket 11 and the support bracket 12 are disposed side by side from front to rear. An upper end of the holding bracket 11 and an upper end of the support bracket 12 are longitudinally hinged. An angle adjustment assembly 70 is disposed on the support bracket 12. The angle adjustment assembly 70 is configured to adjust an inclined angle of the holding bracket 11. The protruding portion 50 and the hanging bar 20 are disposed on the upper end of the holding bracket 11. The support bracket 12 is disposed below the positioning clamping gap 30. The support bracket 12 is placed on the front side of the steering wheel, and the hanging bar 20 is unfolded and hung on the upper portion of the steering wheel, thereby fixing the holding bracket 11 relative to the steering wheel. At this time, after the laptop is placed on the holding bracket 11, the inclined angle of the holding bracket 11 and an inclined angle of the laptop are adjusted through the angle adjustment assembly 70, thereby facilitating the user to select a suitable angle to operate and watch the laptop.

In one embodiment of the present disclosure, the angle adjustment assembly 70 comprises a support rod 71, a sliding block 72, and a positioning unit 73. The support rod 71 is longitudinally hinged to the support bracket 12. The sliding block 72 is slidably disposed on the support bracket 12. The positioning unit 73 is configured to position a position of the sliding block 72. Alternatively, the sliding lock 72 is disposed on the support bracket 12, and the support rod 71 is longitudinally hinged to the holding bracket 11.

Specifically, the support rod 71 is longitudinally hinged to the sliding block 72. When the sliding block 72 is controlled to slide up and down to a desired position, the sliding block 72 is fixed by the positioning unit 73 so that the support rod 71, the holding bracket 11 and the support bracket 12 form a stable triangular structure, thereby realizing an adjustment of the laptop to a required height and maintaining stability. In practice, a position of the connecting point between the support rod 71 and the support bracket 12 is higher than a highest position of the sliding block 72, so that a lower end of the support rod 71 is lower than an upper end of the support rod 71.

In one embodiment of the present disclosure, the positioning unit 73 comprises a movable piece 730, snapping grooves 732, and an elastic abutting piece 733. The movable piece 730 is longitudinally hinged to the sliding block 72. The snapping grooves 732 are evenly defined in the holding bracket 11. The snapping grooves 732 are corresponding to a sliding track of the sliding block 72. The elastic abutting piece 733 is configured to provide an abutting force to force one end of the movable piece 730 to snap into one of the snapping grooves 732. The elastic abutting piece 733 is a spring. Of course, the elastic abutting piece 733 may be a torsion spring or an elastic metal sheet in other alternate embodiments.

Specifically, a movable slot 721 is defined in a rear sidewall of the sliding block 72. The movable slot 721 penetrates through the sliding block 72 from rear to front. The movable piece 730 is disposed in the movable slot 721 and is rotatably connected to the sliding block 72 through a second rotating shaft 80. The elastic abutting piece 733 is disposed above the second rotating shaft 80. A first end of the elastic abutting piece 733 abuts against the sliding block 72, and a second end of the elastic abutting piece 733 abuts against the movable piece 730. One end of the support rod 71 connected to the sliding block 72 is located above the elastic abutting piece 733. When assembled in place, an upper end of the movable piece 730 extends out of the movable slot 721, so that the movable piece 730 and the sliding block 72 jointly form a rack-drag mechanism that is only allowed to be moved upwards in one direction. In an initial state, that is, when the inclined angle of the holding bracket 11 is kept unchanged, a lower end of the movable piece 730 is snapped in one of the snapping grooves 732 by the elastic force of the elastic abutting piece 733. At this time, the second rotating shaft 80 transmits an reaction force received by the lower end of the movable piece 730 to the support rod 71 through the sliding block 72, so that the holding bracket 11 is supported at a corresponding height.

When it is necessary to adjust the laptop to a higher position, the user is able to directly drag the sliding block 72 to slide upward. During the sliding process of the sliding block, since an angle between the lower end of the movable piece 730 and the holding bracket 11 is an acute angle, the lower end of the movable piece 730 is able to automatically move out of a current snapping groove 732 through the elastic abutting piece 733 and automatically enter a next snapping groove 732. An adjustment process thereof is extremely convenient and fast.

When it is necessary to lower the height of the laptop, it is only necessary to press the upper end of the movable piece 730 in the movable slot 721, so that the lower end of the movable piece 730 backwardly moves out of the current snapping groove 732. At this time, the user is able to slide the sliding block 72 downward. When the laptop lowers to the required position, the user may release the upper end of the movable piece 730 and the lower end of the movable piece 730 is re-snapped into a corresponding one of the snapping grooves 732 to complete a positioning of the holding bracket 11.

Specifically, the sliding block 70 is a cuboid, and the movable piece 730 is a rectangular plate. The second rotating shaft 80 is fixedly connected in parallel to one side of the movable piece 730.

In one embodiment of the present disclosure, the holding bracket 11 comprises two guide ribs 90. The guide ribs 90 are parallel to the sliding track of the sliding block 72. The two guide ribs 90 are respectively disposed on a left side and a right side of the sliding track of the sliding block 72. Guide groove 91s are defined in two opposite sidewalls of the two guide ribs 90 along a length direction of the holding bracket. Guide protrusions 722 matched with the guide groove 91s are disposed on the sliding block 72. When assembled in place, the two guide ribs 90 are slidably attached to the sliding block 72. Through a dual guiding limiting function of the guide protrusions 722, the guide grooves 91 and the guide ribs 90, the stability of the sliding block 72 sliding up and down is ensured, and the user can easily slide the sliding block. The user is able to blindly push the sliding block without eyeing the sliding block 72 during an entire process of sliding of the sliding block 72.

In the embodiment, a space between the two guide ribs 90 forms a storage groove of the support rod 71. When the holding bracket 11 and the support bracket 12 are folded and overlapped, the support bracket 12 is attached to the two guide ribs 90 and are enclosed with the storage groove to form a storage cavity 100 of the support rod 71 and the sliding block 72, so that the sliding block 72 and the support rod 71 are well protected after storage. Moreover, it further avoids scattering of the support rod 71 and the sliding block 72, and improves the compactness of the overall structure of the electronic device holder.

In one embodiment of the present disclosure, the holding bracket 11 and the support bracket 12 are rectangular. A length of the holding bracket 11 is greater than a length of the support bracket 12. When the holding bracket 11 is assembled in place, the lower end of the holding bracket 11 is located below a lower end of the support bracket 12. Therefore, a situation where a length of the lower end of the electronic device holder after being assembled on the steering wheel is too large and affects the movement of the thighs of the user is avoided. The lower end of the holding bracket 11 extends downward longer than that of the support bracket 12, which facilitates the user to adjust a distance between the laptop placed on the holding bracket 11 and the body.

In one embodiment of the present disclosure, a stopper 110 is foldably disposed on a lower end of a front side of the holding bracket 11. The stopper 110 is configured to prevent an electronic device from sliding off the holding bracket 11.

Specifically, the stopper 110 is in a strip shape and is longitudinally hinged with the holding bracket 11 through a third rotating shaft 120. In order to further enhance the integrity of the stopper 110 after being assembled with the holding bracket 11, a storage hole 130 corresponding to the stopper 110 is defined on the holding bracket 11. The stopper 110 is rotatable in the storage hole 130. The stopper 110 is movably disposed in the storage hole 130. Two ends of the third rotating shaft 120 are respectively fixed to a left sidewall and a right sidewall of the storage hole 130. When the stopper 110 is rotated in place, a portion of a front wall of the stopper 110 above the third rotary shaft 120 abuts against a bottom inner wall of the storage hole 130. Two fixed points are formed by the third rotating shaft 120 and the bottom inner wall of the storage hole 130, so that the stopper 110 is positioned in a vertical state. At this time, the stopper 110 abuts against a lower end of the laptop when the laptop is placed on the front wall of the holding bracket 11, thereby preventing the laptop from continuing to slide down and falling off the holding bracket. In order to prevent the lower end of the laptop from accidentally moving towards the user, a limiting arm 11 facing the laptop is disposed on one end of the stopper 110 away from the third rotation shaft 120.

In one embodiment of the present disclosure, the at least one bracket body 10 comprises two bracket bodies 10 disposed from left to right. The vehicle-mounted electronic device holder further comprises a spacing adjustment assembly 140 configured to adjust a distance between the two bracket bodies 10. In this way, the electronic device holder is adapted to steering wheels of different sizes. Further, spacing adjustment assembly 140 facilitates storage of the electronic device holder. When the user does not use the electronic device holder, the two bracket bodies 10 are folded together.

Specifically, the spacing adjustment assembly 140 is a prismatic collapsible frame. The spacing adjustment assembly 140 comprises four connecting rods 141 configured as four sides of the prismatic collapsible frame. Fourth rotating shafts 142 are disposed on four intersections of the four connecting rods 141. That is, each two adjacent connecting rods are hinged with each other through a corresponding one of the fourth rotating shafts 142. During assembly, a first group of diagonal angles of the prismatic collapsible frame is disposed in a direction parallel to the holding bracket 11, and a second group of diagonal angles extends to form four end portions 143. The four connecting rods respectively extend to form the four end portions 143. Furthermore, two end portions 143 on an upper side of left and right ends of the prismatic collapsible frame are respectively hinged longitudinally with the two holding brackets 11 through hinge shafts, and the other two end portions 143 on the lower side of the prismatic collapsible frame are respectively slidably connected longitudinally with the two holding brackets 11. Therefore, the prismatic collapsible frame retracts in a lateral direction when the two end portions 143 on the lower side thereof slide upward, and thus increasing the spacing between the two holding brackets 11. When the two ends portion 143 on the lower side of the prismatic collapsible frame move downward, a prismatic shape formed by the prismatic collapsible frame is collapsed toward a middle thereof and a length of a diagonal line in a longitudinal direction increases, thereby reducing the spacing between the two brackets 11.

It should be understood that for those skilled in the art, modifications or modifications may be made in accordance with the foregoing description, and all such modifications and modifications shall fall within the protection scope of the appended claims of the present disclosure.

What is claimed is:

1. A vehicle-mounted electronic device holder, comprising:
at least one bracket body; and
a hanging bar foldably disposed on a rear surface of an upper end of the at least one bracket body;
wherein when the hanging bar is unfolded in place, a positioning clamping gap for clamping a steering wheel is formed between the hanging bar and the rear surface of the upper end of the at least one bracket body.

2. The vehicle-mounted electronic device holder according to claim 1, wherein the at least one bracket body comprises an accommodating slot, and in a folded state, the hanging bar is accommodated in the accommodating slot.

3. The vehicle-mounted electronic device holder according to claim 2, wherein the accommodating slot penetrates through the at least one bracket body from front to rear.

4. The vehicle-mounted electronic device holder according to claim 2, wherein the upper end of the at least one bracket body comprises a protruding portion protruding forwardly, a rear side of the protruding portion defines a recess, and the accommodating slot is defined in the recess.

5. The vehicle-mounted electronic device holder according to claim 4, wherein the protruding portion is L-shaped, the protruding portion comprises a lateral end facing backward and a longitudinal end, the hanging bar is disposed on the longitudinal end of the protruding portion, and the accommodating slot extends from the longitudinal end to the lateral end of the protruding portion,
wherein when the hanging bar is in a storage state, a tail end of the hanging bar is located at a connection between the lateral end and the longitudinal end of the protruding portion.

6. The vehicle-mounted electronic device holder according to claim 1, wherein a limiting block is disposed on the rear surface of the upper end of the at least one bracket body, the limiting block is disposed above the hanging bar, and when the hanging bar is unfolded in place, the hanging bar abuts against a lower end of the limiting block.

7. The vehicle-mounted electronic device holder according to claim 6, wherein a positioning groove configured to position the hanging bar is defined in the lower end of the limiting block, and when the hanging bar is unfolded in place, the hanging bar is positioned in the positioning groove.

8. The vehicle-mounted electronic device holder according to claim 1, wherein a head end of the hanging bar is longitudinally hinged to the at least one bracket body by a first rotating shaft, the hanging bar comprises an arc-shaped recess adapted to an arc-shaped outer edge of the steering wheel, and when the hanging bar is unfolded in place, the arc-shaped recess is attached to an upper portion of the arc-shaped outer edge of the steering wheel.

9. The vehicle-mounted electronic device holder according to claim 8, wherein when the hanging bar is in a storage state, a tail end of the hanging bar is accommodated in a lower portion of the positioning clamping gap.

10. The vehicle-mounted electronic device holder according to claim 8, wherein the hanging bar is columnar and has a ball head disposed on a tail end thereof, and the ball head and the hanging bar are integrated and are coaxially disposed.

11. The vehicle-mounted electronic device holder according to claim 1, wherein the at least one bracket body comprises a holding bracket and a support bracket, the holding bracket and the support bracket are disposed side by side from front to rear, and an upper end of the holding bracket and an upper end of the support bracket are longitudinally hinged;
wherein an angle adjustment assembly is disposed on the support bracket, the angle adjustment assembly is configured to adjust an inclined angle of the holding bracket, the hanging bar is disposed on the upper end of the holding bracket, and the support bracket is disposed below the positioning clamping gap.

12. The vehicle-mounted electronic device holder according to claim 11, wherein the angle adjustment assembly comprises a support rod, a sliding block, and a positioning unit;
wherein the support rod is longitudinally hinged to the support bracket, the sliding block is slidably disposed on the support bracket, the positioning unit is configured to position a position of the sliding block, and the support rod is longitudinally hinged to the sliding block.

13. The vehicle-mounted electronic device holder according to claim 12, wherein the positioning unit comprises a movable piece, snapping grooves, and an elastic abutting piece;
wherein the movable piece is longitudinally hinged to the sliding block, the snapping grooves are evenly defined in the holding bracket, the snapping grooves are corresponding to a sliding track of the sliding block, and the elastic abutting piece is configured to provide an abutting force to force one end of the movable piece to snap into one of the snapping grooves.

14. The vehicle-mounted electronic device holder according to claim 13, wherein a movable slot is defined in a rear sidewall of the sliding block, the movable slot penetrates through the sliding block from rear to front, the movable piece is disposed in the movable slot and is rotatably connected to the sliding block through a second rotating shaft, and the elastic abutting piece is disposed above the second rotating shaft;
wherein one end of the support rod connected to the sliding block is located above the elastic abutting piece, and when assembled in place, an upper end of the movable piece extends out of the movable slot.

15. The vehicle-mounted electronic device holder according to claim 13, wherein the holding bracket comprises two guide ribs, and the two guide ribs are respectively disposed on a left side and a right side of the sliding track of the sliding block, guide grooves are defined in two opposite sidewalls of the two guide ribs along a length direction of the holding bracket, guide protrusions matched with the guide grooves are disposed on the sliding block, and when assembled in place, the two guide ribs are slidably attached to the sliding block.

16. The vehicle-mounted electronic device holder according to claim 11, wherein the holding bracket and the support bracket are rectangular, a length of the holding bracket is greater than a length of the support bracket, and when the holding bracket is assembled in place, the lower end of the holding bracket is located below a lower end of the support bracket.

17. The vehicle-mounted electronic device holder according to claim 11, wherein a stopper is disposed on a lower end of a front side of the holding bracket, and the stopper is configured to prevent an electronic device from sliding off the holding bracket.

18. The vehicle-mounted electronic device holder according to claim 11, wherein the at least one bracket body comprises two bracket bodies disposed from left to right, the vehicle-mounted electronic device holder further comprises a spacing adjustment assembly configured to adjust a distance between the two bracket bodies.
